(19) United States
(12) Patent Application Publication
(10) Pub. No.: US 2007/0116467 A1
(43) Pub. Date: May 24, 2007

(54) Passive optical network

(75) Inventors: Jin-Wook Kwon, Suwon-si (KR); Joong-Wan Park, Suwon-si (KR); Joong-Hee Lee, Seongnam-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/442,042

(22) Filed: May 26, 2006

(30) Foreign Application Priority Data
Nov. 23, 2005 (KR) 2005-112350

(51) Int. Cl. H04J 14/00

(52) U.S. Cl. 398/72

(57) ABSTRACT

A point-to-multi-point passive optical network (PON) includes: an optical line terminal (OLT) comprising an optical transceiver for generating a downstream optical signal and a monitoring signal and for detecting an upstream optical signal; a plurality of optical network units (ONUs) for detecting the downstream optical signal, reflecting the monitoring signal to the OLT, and transmitting a data-modulated upstream optical signal in a designated time slot; and an optical fiber for connecting the ONUs and the OLT.

### CLAIM OF PRIORITY

This application claims priority under 35 U.S.C. § 119 to an application entitled “Passive Optical Network,” filed in the Korean Intellectual Property Office on Nov. 23, 2005 and assigned Serial No. 2005-112350, the contents of which are incorporated herein by reference.

### BACKGROUND OF THE INVENTION

1. Field of the Invention

The present invention relates generally to a passive optical network (PON), and in particular, to a point-to-multi-point Ethernet PON (EPON) for monitoring normality/abnormality thereof.

2. Description of the Related Art

An optical time domain reflectometer (OTDR) is used for monitoring normality/abnormality of an optical fiber or optical cable. It calculates the return time and the intensity of light by inputting pulse type light into a target optical fiber, and it detects light reflected and returned due to diffusion at a specific position of the optical fiber where abnormality occurs. Further, the abnormality type can be determined based on the calculated return time and intensity of light. The OTDR can monitor the entire configuration by being connected to one end of an optical fiber or optical cable, thereby reducing the time and cost required to monitor the network. In detail, the OTDR can provide information such as a loss per unit length, evaluation of a splice and connector, the calculation of an abnormality occurrence position, and so on.

Monitoring an optical communication subscriber network(EPON) using the OTDR has been suggested, e.g., an in-service or active fiber testing method in which the OTDR is inserted into an existing optical subscriber network. A typical network management system controls a complex network to maximize the efficiency and productivity of the network and performing a realtime network monitoring and control to optimize the performance of the network. However, if the OTDR is applied to an EPON using a point-to-multi-point scheme, instead of a conventional point-to-point scheme, the cost and time loss increases. That is, since a plurality of optical network units (ONUs) are linked to a single optical line terminal (OLT) in a conventional optical subscriber network, the conventional optical subscriber network must be monitored in realtime by incorporating an expensive OTDR thereto. Furthermore, a separate manager for managing the OTDR is required.

Accordingly, there is a need for a network, which overcomes the problems associated with the prior art.

### SUMMARY OF THE INVENTION

The present invention relates to an Ethernet passive optical network (EPON) including devices for performing a realtime monitoring of the EPON at low cost.

According to one aspect of the present invention, there is provided a point-to-multi-point passive optical network (PON) comprising: an optical line terminal (OLT) including an optical transceiver for generating a downstream optical signal and a monitoring signal and for detecting an upstream optical signal; a plurality of optical network units (ONUs) for detecting the downstream optical signal, reflecting the monitoring signal to the OLT, and transmitting a data-modulated upstream optical signal in a designated time slot; and an optical fiber for connecting the ONUs and the OLT.

### BRIEF DESCRIPTION OF THE DRAWINGS

The above features and advantages of the present invention will become more apparent from the following detailed description when taken in conjunction with the accompanying drawings in which:

FIG. 1 is a configuration of a point-to-multi-point PON according to an embodiment of the present invention;

FIG. 2 is a block diagram of an optical transceiver of FIG. 1; and

FIG. 3 is a block diagram of each ONU of FIG. 1.

### DETAILED DESCRIPTION OF THE INVENTION

Embodiments of the present invention will be described herein below with reference to the accompanying drawings. In the drawings, the same or similar elements are denoted by the same reference numerals even though they are depicted in different drawings. For the purposes of clarity and simplicity, well-known functions or constructions are not described in detail as they would obscure the invention in unnecessary detail.

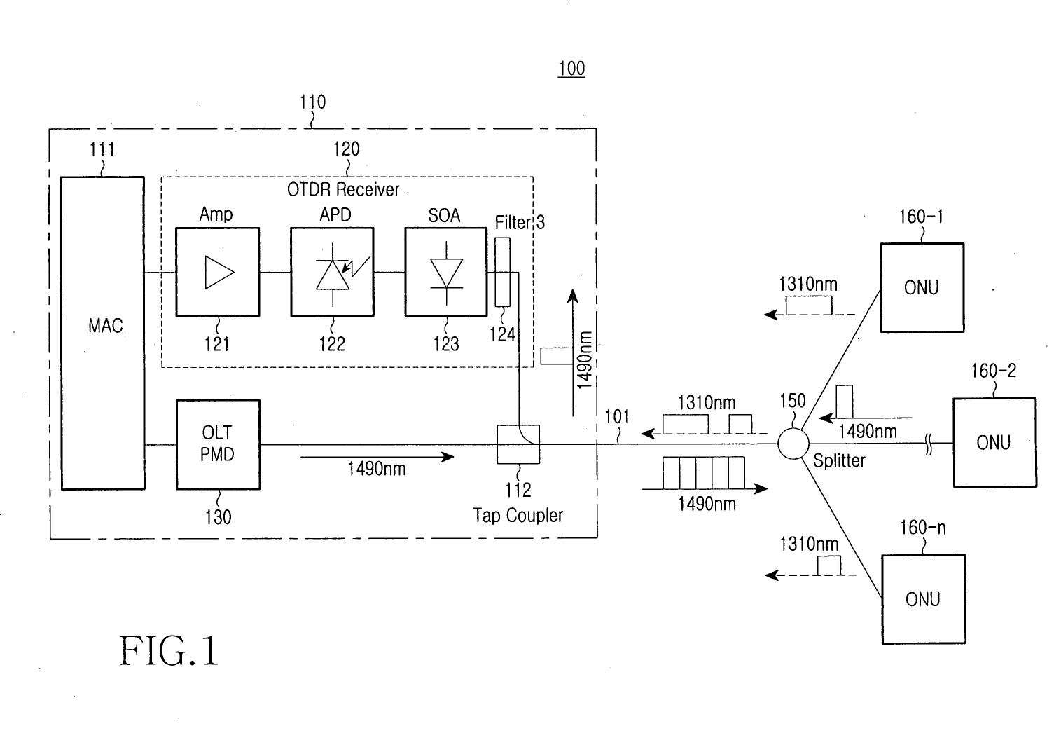

FIG. 1 is a configuration of a point-to-multi-point PON 100 according to an embodiment of the present invention. As shown the point-to-multi-point PON 100 includes an optical line terminal (OLT) 110 including an optical transceiver (OLT PMD) 130 for generating a downstream optical signal and a monitoring signal (1490 nm) and for detecting an upstream optical signal (1310 nm), a plurality of optical network units (ONUs) 160-1 to 160-n for detecting the downstream optical signal, reflecting the monitoring signal to the OLT 110, and transmitting a data-modulated upstream optical signal in a designated time slot, an optical splitter 150 located between the OLT 110 and the ONUs 160-1 to 160-n, and an optical fiber 101 for coupling the OLT 110 and the ONUs 160-1 to 160-n.

The OLT 110 includes an optical detector (OTDR receiver) 120 for detecting the monitoring signal reflected by each of the ONUs 160-1 to 160-n, a tap coupler 112, which is located between the optical transceiver 130 and the ONUs 160-1 to 160-n, outputs the monitoring signal reflected by each of the ONUs 160-1 to 160-n to the optical detector 120, and outputs the upstream optical signal to the optical transceiver 130. The OLT 110 further includes a media access controller (MAC) 111 for outputting the downstream optical signal to the ONUs 160-1 to 160-n and monitoring normality/abnormality of the PON 100 using the monitoring signal detected by the optical detector 120.

For the upstream optical signal and the downstream optical signal, different wavelength bands can be used. For example, when 1490 nm is used for a wavelength band of the downstream optical signal, 1310 nm can be used for a wavelength band of the upstream optical signal. The downstream optical signal is transmitted to each of the ONUs 160-1 to 160-n, and the OLT 110 can identify each of the ONUs 160-1 to 160-n since each upstream optical signal is transmitted in the corresponding time slot. That is, in an optical subscriber network according to the embodiment, a time division multiplexing access (TDMA) scheme in which a time slot is designated can be applied to each of ONUs.

In detail, in the embodiment, a master/slave TDMA scheme of an asynchronous transfer mode PON (ATM-PON) can be applied, the scheme in which the OLT 110 plays a role of designating a time slot to each of the ONUs 160-1 to 160-n and each of the ONUs 160-1 to 160-n plays a role of a slave for requesting the OLT 110 for a needed time slot. Here, a multi point control protocol (MPCP) can be used. The MPCP can use five new MAC control frames (MPCPDUs: MPCP data units), ‘GRANT’ and ‘REPORT’ of which are used the most.

The MAC 111 determines normality/abnormality between the MAC 111 and each of the ONUs 160-1 to 160-n from the amplitude of the monitoring signal detected by the optical detector 120 and the time taken until the reflected light returns, then calculates an abnormality occurrence position when the abnormality occurs. The MAC 111, as a master, collects time slots which the ONUs 160-1 to 160-n request, designates an appropriate time slot to each of the ONUs 160-1 to 160-n, and, if necessary, can control the optical transceiver 130 to generate the monitoring signal.

The MAC 111 designates a time slot indicating an available upstream transmission start time and a transmission duration to each of the ONUs 160-1 to 160-n using ‘GRANT’ and provides to each of the ONUs 160-1 to 160-n a chance for transmitting ‘REPORT’ by periodically transmitting ‘GRANT’ to each of the ONUs 160-1 to 160-n.

‘GRANT’ transmitted by the OLT 110 includes ‘Discovery GRANT’ for providing a chance for an unregistered ONU to be registered, ‘Forced Report GRANT’ for informing an ONU in an idle state when there is no data in an upstream buffer, a data state, and ‘Data GRANT’ for general data transmission. Note that different types of ‘GRANT’ can be identified using a flag field.

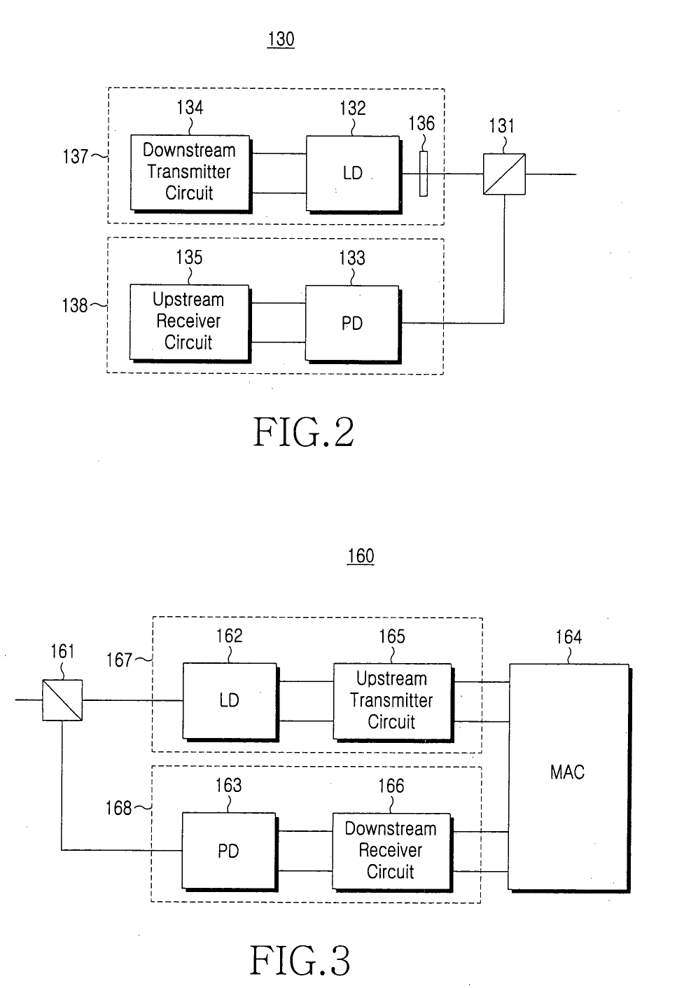

FIG. 2 is a block diagram of the optical transceiver 130 shown in FIG. 1. As shown, the optical transceiver 130 includes a downstream transmitter 137 for generating the downstream optical signal, an upstream receiver 138 for detecting the upstream optical signal, and a wavelength selection coupler 131. The optical transceiver 130 is a single device and is connected to the optical fiber 101 via an optical connector (not shown) of the OLT 110.

The wavelength selection coupler 131 is coupled to the tap coupler 112, outputs the upstream optical signal input through the tap coupler 112 to an optical receiver 133, and outputs the downstream optical signal generated by a light source 132 to the tap coupler 112. If a coupling ratio of the tap coupler 112 is 8:2, a 1 dB loss occurs in the coupling of the downstream optical signal, and a 7 dB loss occurs in the coupling of the monitoring signal having a pulse pattern to the optical detector 120.

The downstream transmitter 137 includes the light source 132 for generating the downstream optical signal, a downstream transmitter circuit 134 for driving the light source 132, and an optical isolator 136 for preventing an unnecessary optical signal from being input to the light source 132. The upstream receiver 138 includes the optical receiver 133 and an upstream receiver circuit 135 for amplifying a signal detected by the optical receiver 133.

The optical isolator 136 prevents a deterioration of the light source 132 by preventing the monitoring signal generated by the light source 132 from being input to the light source 132 again.

For the light source 132, a semiconductor laser or a semiconductor optical amplifier may be used, and for the optical receiver 133, a photo diode may be used. The MAC 111 controls the downstream transmitter 137 to generate the downstream optical signal and the monitoring signal having a pulse pattern. In addition, if necessary, the MAC 111 controls the downstream transmitter 137 to generate a downstream optical signal according to a time division scheme.

The optical detector 120 includes a filter 124 for passing only a predetermined wavelength of the monitoring signal, a first amplifier 123 for pre-amplifying the monitoring signal input from the filter 124, a photo diode 122 for detecting an electrical signal from the amplified monitoring signal, and a second amplifier 121 for amplifying the electrical signal detected by the photo diode 122 and transmitting the amplified electrical signal to the MAC 111. The optical detector 120 detects the amplitude of the monitoring signal and outputs the detected amplitude of the monitoring signal and a detection time to the MAC 111.

For the first amplifier 123, a semiconductor optical amplifier may be used, and for the photo diode 122, a pin or avalanche photo diode may be used.

FIG. 3 is a block diagram of each ONU 160 of FIG. 1. As shown, each ONU 160 includes an upstream transmitter 167, a downstream receiver 168, a wavelength selection coupler 161 for outputting the upstream optical signal to the OLT 110 and outputting the downstream optical signal to the downstream receiver 168, and a separate MAC 164 for confirming a time slot designated by ‘GRANT’ input from the OLT 110 and generating ‘REPORT’ including a clock.

The upstream transmitter 167 includes a light source 162 for generating a data-modulated upstream optical signal in a designated time slot and an upstream transmitter circuit 165 for driving the light source 162. The downstream receiver 168 includes a downstream optical receiver 163 for detecting the downstream optical signal and a downstream receiver circuit 166 for amplifying a signal detected by the downstream optical receiver 163.

Each of the ONUs 160-1 to 160-n transmits ‘REPORT’ for informing the OLT 110 about the amount of data to be transmitted using a time slot designated by ‘GRANT.’ ONUs unregistered in the OLT 110 among the ONUs 160-1 to 160-n can use MPCPDUs, such as ‘REGISTER_REQ’ for performing a registration provided by ‘GRANT’ of the OLT 110 and ‘REGISTER_ACK’ for terminating the registration process. If a plurality of unregistered ONUs simultaneously transmit ‘REGISTER_REQ’ for registration to the OLT 110, the ‘REGISTER_REQs’ transmitted by the unregistered ONUs may be collided each other. Thus, each of the unregistered ONUs transmits ‘REGISTER_REQ’ at a random time to minimize the collision.

The OLT 110 recognizes the unregistered ONUs from the ‘REGISTER_REQs’ received from the unregistered ONUs and simultaneously transmits ‘REGISTER’ and ‘GRANT’ for registration to the unregistered ONUs, and each of the unregistered ONUs, which has received ‘REGISTER’ and ‘GRANT’ terminates the registration process (synchronization) by transmitting ‘REGISTER_ACK’ to the OLT 110.

All the ONUs 160-1 to 160-n and the OLT 110 must operate based on a reference clock so that upstream optical signals in the respective time slots according to ‘GRANT’ can be normally transmitted without collision. The point-to-multi-point PON 100 defines a reference clock of the ONUs 160-1 to 160-n in the MAC 111 of the OLT 110 and performs synchronization by transmitting the reference clock together when the OLT 110 transmits ‘GRANT’ to the ONUs 160-1 to 160-n. Thus, the ONUs 160-1 to 160-n are synchronized by the reference clock while performing the registration process with the OLT 110 and transmits clock information to the OLT 110 through ‘REPORT.’

The OLT 110 and each of the ONUs 160-1 to 160-n are separated from each other by a distance according to a set position of each of the ONUs 160-1 to 160-n, and accordingly, an information difference according to a transmission delay time of the reference clock occurs. To compensate for the transmission delay time, the OLT 110 can prevent the collision between upstream optical signals by always measuring a distance from each of the ONUs 160-1 to 160-n and allocating a time slot compensated by the distance between the OLT 110 and each of the ONUs 160-1 to 160-n to each of the ONUs 160-1 to 160-n. A round trip time (RTT) between the OLT 110 and each of the ONUs 160-1 to 160-n can be calculated by a difference between a clock included in ‘REPORT’ received from each of the ONUs 160-1 to 160-n and the reference clock designated to the OLT 110.

The optical detector 1.20 does not operate in the PON 100 in a normal operation state but operates when the PON 100 is changed to an OTDR mode by a control of the MAC 111. Since the OLT 110 and each of the ONUs 160-1 to 160-n are located separately from each other by a set distance, each of the ONUs 160-1 to 160-n always measures and compensates for a distance with the OLT 110. Thus, an operational state of each of the ONUs 160-1 to 160-n can be electrically observed. In addition, the MAC 164 of each of the ONUs 160-1 to 160-n may monitor an optical transmission link state of the PON 100 in realtime by being periodically changed to the OTDR mode. That is, if an OTDR signal of any one of the ONUs 160-1 to 160-n is not received for a long time, the OLT 110 determines that one of three abnormal states described below occurs and confirms normality/abnormality with the ONU whose OTDR signal has not been received as well as an abnormality occurrence position, and an abnormality type.

The three abnormal states are: firstly, abnormality on a line between each of the ONUs 160-1 to 160-n and the OLT 110; secondly, abnormality of each of the ONUs 160-1 to 160-n and the OLT 110; and thirdly, an operation stop state due to non-use of each of the ONUs 160-1 to 160-n for a long time. The abnormality due to non-use of each of the ONUs 160-1 to 160-n for a long time can be determined according to whether each of the ONUs 160-1 to 160-n responses and is not determined as an actual abnormal state.

As an example, a case where abnormality occurs between a specific ONU 160 and the OLT 110 in the PON 100 will now be described. Since the specific ONU 160 and the OLT 110 continuously manages the PON 100 using the RTT, the OLT 110 detects normality/abnormality with respect to the specific ONU 160. If abnormality with the specific ONU 160 is detected, the OLT is changed to the OTDR mode by the MAAC 111, and the optical transceiver 130 generates a monitoring signal. The monitoring signal is transmitted to the ONUs 160-1 to 160-n, reflected at an abnormality occurrence position between the OLT 110 and the specific ONU 160, and returned to the OLT 110.

The optical detector 120 of the OLT 110 detects the reflected and returned monitoring signal and informs the MAC 111 of the detection result. Thereafter, the MAC 111 can find the abnormality occurrence position by calculating the RTT of the monitoring signal.

As described above, according to embodiments of the present invention, by generating a monitoring signal used by an OTDR using an optical transceiver for generating an optical signal in an EPON, management and monitoring of the EPON is easy, and a configuration of the EPON is simplified, thereby being effective in the terms of cost, time, and human operation.

While the invention has been shown and described with reference to a certain preferred embodiment thereof, it will be understood by those skilled in the art that various changes in form and details may be made therein without departing from the spirit and scope of the invention as defined by the appended claims.

WHAT IS CLAIMED IS:

1. A point-to-multi-point passive optical network (PON) comprising:
an optical line terminal (OLT) having an optical transceiver for generating a downstream optical signal and a monitoring signal and for detecting an upstream optical signal;
a plurality of optical network units (ONUs) for detecting the downstream optical signal, reflecting the monitoring signal to the OLT, and transmitting a data-modulated upstream optical signal in a designated time slot; and
an optical fiber for coupling the ONUs and the OLT.

2. The PON of claim 1, wherein the OLT comprises:
an optical detector for detecting the monitoring signal reflected by each of the ONUs;
a tap coupler, disposed between the optical transceiver and the ONUs, outputs the monitoring signal reflected by each of the ONUs to the optical detector, and outputs the upstream optical signal to the optical transceiver; and
a media access controller (MAC) for outputting the downstream optical signal to the ONUs and for monitoring normality/abnormality of the PON based on the monitoring signal detected by the optical detector.

3. The PON of claim 1, wherein the optical transceiver comprises:
a downstream transmitter for generating the downstream optical signal;
an upstream receiver for detecting the upstream optical signal; and
a wavelength selection coupler for outputting the downstream optical signal to each of the ONUs and outputting the upstream optical signal to the upstream receiver.

4. The PON of claim 3, wherein the downstream transmitter comprises:
a light source for generating the downstream optical signal;
a downstream transmitter circuit for driving the light source; and
an optical isolator for preventing an unnecessary optical signal from being input to the light source.

5. The PON of claim 3, wherein the upstream receiver comprises:
an optical receiver for detecting the upstream optical signal; and
an upstream receiver circuit for amplifying a signal detected by the optical receiver.

6. The PON of claim 2, wherein the optical detector comprises:
a filter for passing only a wavelength of the monitoring signal;
a first amplifier for pre-amplifying the monitoring signal input from the filter;
a photo diode for detecting an electrical signal from the amplified monitoring signal; and
a second amplifier for amplifying the electrical signal detected by the photo diode and transmitting the amplified electrical signal to the MAC.

7. The PON of claim 1, further comprising an optical splitter, disposed between the OLT and the ONUs, splits the amplitude of the downstream optical signal and outputs the split downstream optical signal to the ONUs, and outputs upstream optical signals in respective time slots to the OLT.

8. The PON of claim 1, wherein each of the ONUs comprises:
an upstream transmitter for generating a data-modulated upstream optical signal in a designated time slot;
a downstream receiver for detecting the downstream optical signal;
a wavelength selection coupler for outputting the upstream optical signal to the OLT and outputting the downstream optical signal to the downstream receiver; and
a MAC for confirming a time slot designated by the OLT.

9. The PON of claim 8, wherein the upstream transmitter comprises:
a light source for generating a data-modulated upstream optical signal in a designated time slot; and
an upstream transmitter circuit for driving the light source.

10. The PON of claim 8, wherein the downstream receiver comprises:
a downstream optical receiver for detecting the downstream optical signal; and
a downstream receiver circuit for amplifying a signal detected by the downstream optical receiver.
